(19) United States
(12) Patent Application Publication
(10) Pub. No.: US 2010/0279067 A1
(43) Pub. Date: Nov. 4, 2010

(54) GLASS SHEET HAVING ENHANCED EDGE STRENGTH

(76) Inventors: Robert Sabia, Corning, NY (US); Sergio Tsuda, Painted Post, NY (US)

Correspondence Address: CORNING INCORPORATED, SP-TI-3-1, CORNING, NY, 14831, US

(21) Appl. No.: 12/433,342

(22) Filed: Apr. 30, 2009

(51) Int. Cl. B32B 3/02; B32B 3/00; C03B 21/02

(52) U.S. Cl. 428/141; 428/192; 65/97

(57) ABSTRACT

A glass sheet having enhanced edge strength. The glass sheet is down-drawn and has at least one laser-formed edge having a minimum edge strength of at least about 90 MPa. The laser-formed edge is substantially free of a chamfer or a bevel. The glass sheet can be strengthened after formation of the edge and is adaptable for use as a cover plate for display and touch screen applications, or as a display or touch screen for information-related terminal (IT) devices; as well as in other applications.

### BACKGROUND

Glass sheets are widely used as protective cover plates for display and touch screen applications, such as portable communication and entertainment devices and for information-related terminal (IT) devices, and in other applications as well. Such devices employ glass products that are produced via conventional finishing processes including scoring and breaking, fixed abrasive wheel edging, fixed abrasive tool chamfering, and lapping and polishing.

The manner in which discrete parts are separated from a large sheet of glass via scoring and breaking—or, alternatively, cutting—introduces significant damage. Subsequent finishing process steps such as, for example, edging and chamfering, attempt to remove the damage caused by scoring and breaking.

Edging and chamfering operations are intended to eliminate damage that leads to low edge strength and failure. Chamfering of edges can generate chips that must be removed by additional lapping and polishing of the faces of the glass, which increases the cost of the glass cover plate in terms of process steps. Lapping and polishing reduce the thickness of the formed glass plate or sheet. The glass must therefore have an initial as-made thickness that is greater than the final product thickness to allow for the reduction by lapping and polishing. Finally, any advantage offered by forming a glass with a surface having a low roughness is lost as a result of finishing.

### SUMMARY

A glass sheet having enhanced edge strength is provided. The glass sheet is down-drawn and has at least one laser-formed edge. The laser-formed edge is substantially free of a chamfer or a bevel and has a minimum edge strength of at least about 90 MPa. The glass sheet can be strengthened after formation of the edge and is adaptable for use as a cover plate for display and touch screen applications, or as a display or touch screen for information-related terminal (IT) devices; as well as in other applications.

Accordingly, one aspect of the disclosure is to provide a glass sheet. The glass sheet is down-drawn and comprises at least one surface that is transparent and unpolished, and at least one laser-formed edge that is substantially free of a chamfer or a bevel. The glass sheet has a minimum edge strength of at least about 90 MPa.

A second aspect of the disclosure is to provide a strengthened glass sheet. The strengthened glass sheet is fusion drawn and comprises a first surface and a second surface, and at least one laser-formed edge joining the first surface and the second surface. The at least one laser-cut edge is substantially free of a chamfer or a bevel.

A third aspect of the disclosure is to provide a method of making a glass sheet. The method comprises the steps of providing a down-drawn first glass sheet and separating the glass sheet from the down-drawn first glass sheet along a plane to form the glass sheet from a portion of the down-drawn first glass sheet. Separating the glass sheet comprises laser-forming an edge of the glass sheet along the plane. The edge is substantially free of a chamfer or a bevel and has a minimum edge strength of at least about 90 MPa.

These and other aspects, advantages, and salient features will become apparent from the following detailed description, the accompanying drawings, and the appended claims.

### BRIEF DESCRIPTION OF THE DRAWINGS

FIG. 1 is a schematic representation of a glass sheet;

FIG. 2a is a cross-sectional schematic view of a glass sheet having chamfers on its edges;

FIG. 2b is a cross-sectional schematic view of a glass sheet having bevels on its edges;

FIG. 2c is a cross-sectional schematic view of a glass sheet in which the laser formed-edges are square to the surfaces of the glass sheet;

FIG. 3a is a top schematic view of a glass sheet having rounded corners;

FIG. 3b is a top schematic view of a glass sheet having square corners;

FIG. 4a is a schematic representation of a first process for laser separation of a glass sheet and laser-formation of an edge;

FIG. 4b is a schematic representation of a second process for laser separation of a glass sheet and laser-formation of an edge;

FIG. 5a is an optical micrograph of an edge of a glass sheet that has been mechanically ground;

FIG. 5b is an optical micrograph of a ground edge of a glass sheet that has been mechanically ground and brush polished;

FIG. 5c is an optical micrograph of a laser-formed edge; and

FIG. 6 is a Weibull plot of the vertical edge strength of samples having laser-formed edges and samples having edges that were mechanically ground and polished.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range.

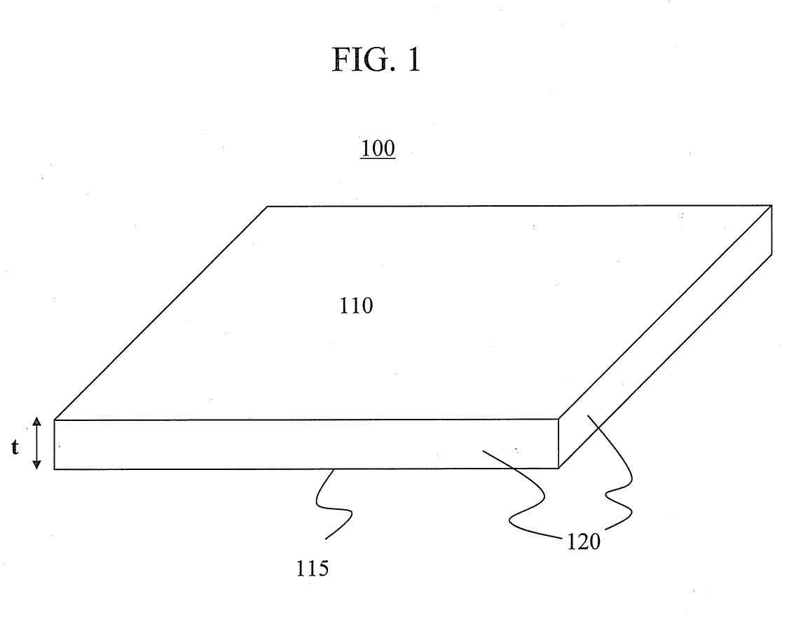

Referring to the drawings in general and to FIG. 1 in particular, it will be understood that the illustrations are for the purpose of describing particular embodiments and are not intended to limit the disclosure or appended claims thereto. The drawings are not necessarily to scale, and certain features and certain views of the drawings may be shown exaggerated in scale or in schematic in the interest of clarity and conciseness.

A glass sheet, schematically shown in FIG. 1, having enhanced edge strength is provided. The glass sheet 100 has at least one unpolished, transparent (i.e., optically clear) surface 110; a second surface 115, which may or may not be transparent and/or unpolished; a thickness t; and at least one laser-formed edge 120 having an minimum edge strength of at least 90 MPa. As used herein, the terms “laser-cut,” “laser-formed,” “laser separated,” and variations thereof are used interchangeably and refer to cutting, dividing or otherwise separating a single piece of glass into at least two pieces. As used herein, the term “minimum edge strength” refers to the minimum strength (rather than the mean edge strength) of edge 120 before glass sheet 100 is subjected to any thermal or chemical strengthening treatment, unless otherwise specified.

Glass sheet 100 has a thickness t of up to about 2 mm. In one embodiment, glass sheet 100 has a thickness t of up to about 2 mm and, in a second embodiment, a thickness t of up to about 1.3 mm. In another embodiment, thickness t is less than or equal to 0.7 mm; in another embodiment, less than or equal to about 0.5 mm; and in yet another embodiment, less than or equal to about 0.3 mm.

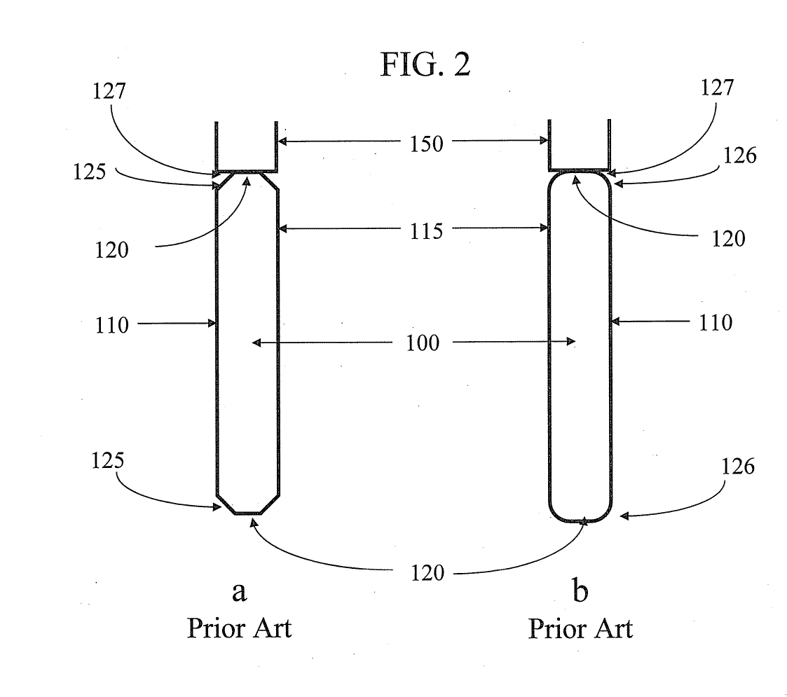

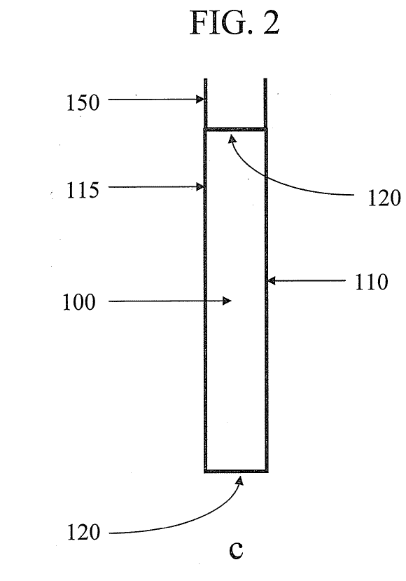

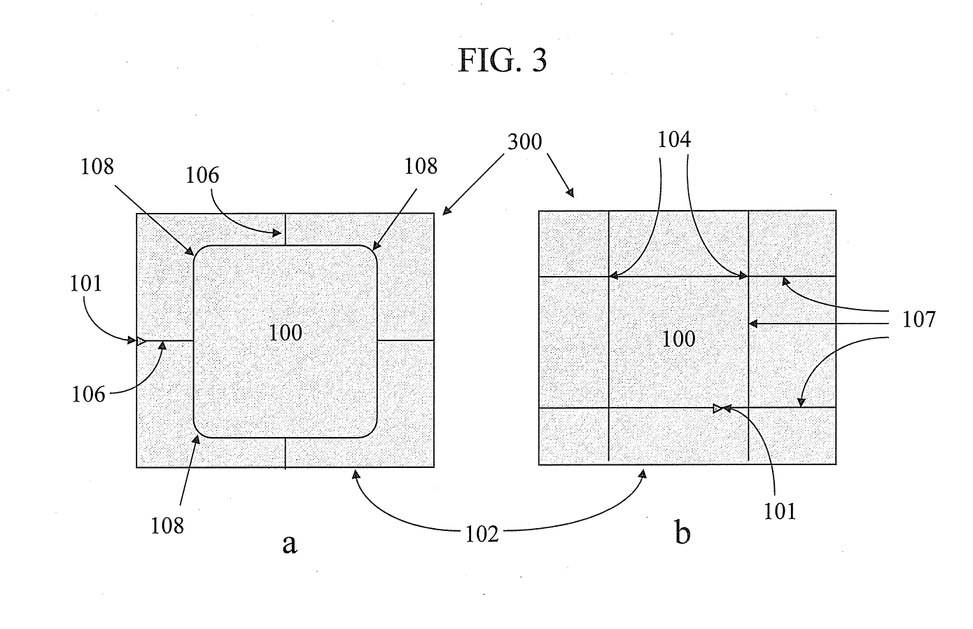

Laser-formed edge 120, in one embodiment, is substantially free of any chamfer or bevel between surface 110, second surface 115, and laser-formed edge 120 that may be thermally or mechanically formed, for example, by either grinding or polishing. As used herein, the term “chamfer” refers to a straight angled break from a face or surface of a glass sheet to the edge; the term “bevel” refers to a radius or curved break from a face or surface of a glass sheet to the edge; and the term “substantially free of” means that the chamfer or bevel is not actively or intentionally added by additional edging steps. A cross-sectional schematic view of an example of two chamfers 125 on a laser formed-edge 120 is shown in FIG. 2a. Similarly, a cross-sectional schematic view of an example of two bevels 126 on a laser formed-edge 120 is shown in FIG. 2b. The presence of chamfers 125 or bevels 126 creates a gap 127 between glass sheet and an adjacent component 150. Gap 127 provides a site for potential damage—such as chipping or crack initiation—to glass sheet 100 during use and accumulation of debris and tramp material, such as dust and dirt. Moreover, the presence of a chamfer 125 or bevel 126 can, in some instances, be obtrusive and therefore aesthetically unpleasing, as its presence accentuates or draws attention to the presence of a seam between adjacent components in a device. In one embodiment, laser-formed edge 120 is square—or perpendicular—to at least one of surface 110 and second surface 115 (FIG. 2c) and no chamfer 125 or bevel 126 is present. The absence of chamfer 125 or bevel 126 and the perpendicular relationship between laser-formed edge 115 and first and second surfaces 110, 115 minimizes or eliminates any gaps between glass sheet 100 and adjacent component 150 that can serve as sites for potential damage or accumulation of dust or debris. In another embodiment, glass sheet 100 has at least one rounded—or radially cut—corner 108, as shown in FIG. 3a.

In one embodiment, the process of separating glass sheet 100 from a larger glass panel begins with the formation of a small initiation crack by a carbide or diamond tip. A laser beam is then focused on the surface of the glass around the initiation crack. Unlike other methods of separating or cutting glass in which the laser beam is elongated so as to cover the entire length or width of the glass sheet, the laser beam used in the present process is focused on a small area of the surface to create a localized stress. The size of the laser beam needed to create the stress depends upon several factors, including the composition, thickness, and coefficient of thermal expansion of the glass. The laser beam is of sufficient size to create stress in a controllable fashion but small enough to prevent creation of a thermal gradient across a large area of the glass panel or sheet, which leads to uncontrollable crack propagation. In one embodiment, the laser beam is generated by an infrared laser such as a 10 μm CO₂ laser or 1.06 μm Nd-YAG laser. The glass surrounding the area struck by the laser beam heats up through absorption of the laser radiation. The glass is treated by a coolant spray of water or other cooling fluids that follows the laser beam as it is translated across the surface of the glass, creating a thermal stress in the glass. The thermal stress splits the glass apart and creates a vent. The glass sample is moved by translation stages, and the crack is propagated by following the desired contour of glass sheet 100. The crack is propagated through the thickness of the glass sheet by irradiating the glass panel with a second laser beam that follows the coolant spray. In one embodiment, the glass sample and laser beam are translated with respect to each other so as to produce a glass sheet 100 having at least one rounded or radially cut corner 108, shown in a schematic top view in FIG. 3a. In those embodiments in which glass sheet 100 having rounded corners 108 is formed, at least one relief cut 106 can be made using the same laser-based technique described hereinabove to release glass sheet 100 from the frame formed by the remainder of the larger glass panel 300.

The process of forming the initiation crack, propagating the median crack, and creating relief cuts can be accomplished in different ways. In one embodiment, the initiating crack 101 is formed at the edges of the glass panel 300 and away (FIG. 3a) from the portion of the glass panel 300 that is to become glass sheet 100. In another embodiment, the initiating crack 101 is formed along the boundary (FIG. 3b) of the portion of the glass panel 300 that is to become glass sheet 100. Relief cuts 106, which are made in the glass panel to release glass sheet 100 from the surrounding frame, can be made by either mechanical scoring using, for example, a diamond tip, or laser scoring, such as that previously described herein. Relief cuts 106 are generally needed only when the closed contour of glass sheet 100 has certain features such as, for example, rounded corners 108 (FIG. 3a). For glass parts that are square or rectangular in shape and have square or straight angle corners 104 (FIG. 3b), only four straight line laser cuts 107 are required to release the glass sheet 100 from the larger glass panel 102.

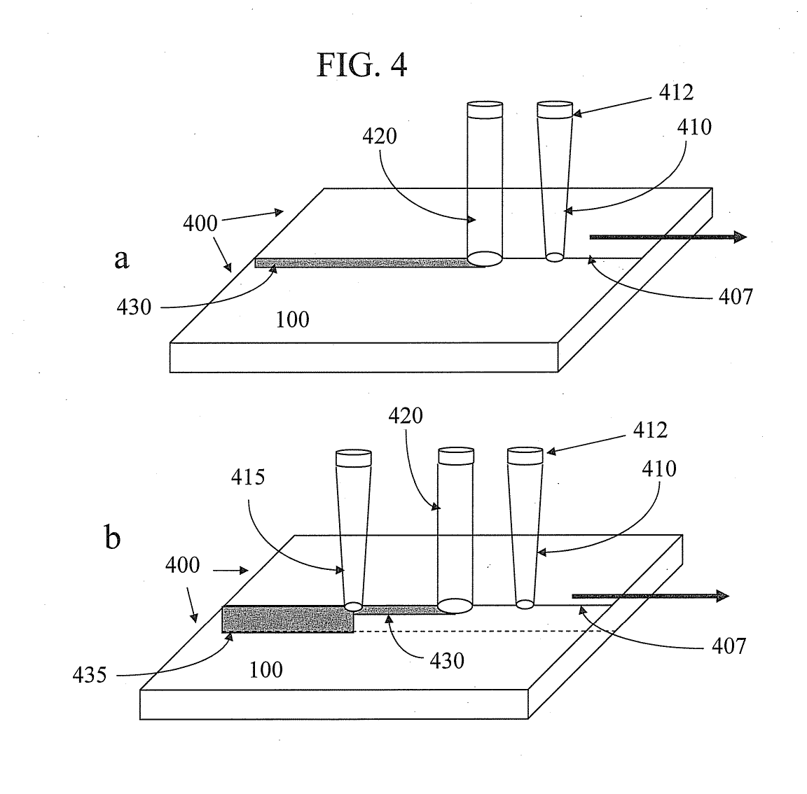

In one embodiment, laser-cut edge 120 is created by propagating an initial crack along a desired contour or line to cut or separate glass sheet 100 from a larger glass sheet. The initial crack is propagated by thermally stressing the glass by first irradiating the larger glass sheet along the contour or line with a laser, followed by quenching the heat transferred by the laser with a coolant spray comprising at least one of a liquid and a gas. In one embodiment, the laser is an infrared laser. In this process, schematically shown in FIG. 4a, a laser beam 410 generated by laser 412 heats first up the surface 405 of glass 400, thereby inducing a thermal or compressive stress in the glass 400. Laser beam 410 and glass 400 are translated with respect to each other such that laser beam 410 travels along the contour or line 407 at which glass 400 is to be separated to form glass sheet 100. In one embodiment, such translation is accomplished by translating at least one of laser beam 410 and glass. Immediately following heating by the laser 410, a coolant spray 420 is directed at the surface 405 along contour or line 407 to quench glass 400, inducing a tensile stress in glass 400. An initial crack is created either mechanically or with a laser. The initial crack is exposed to the sequence of compressive and tensile stress, allowing the initial crack to be propagated along the line 407 corresponding to the path along which laser beam 410 and coolant spray 420 travel. The depth of the crack propagated through glass 400 is a function of multiple parameters such as, but not limited to, the coefficient of thermal expansion (CTE), absorption coefficient of glass 400 at the wavelength of laser beam 410, translation speed of laser beam 410 and glass 400 with respect to each other, time lag between heating by laser beam 310 and quenching by coolant spray 420, and the like. In some embodiments, the crack is not expanded through the entire thickness t of glass 400, and the result of crack propagation is a scribed line with a superficial median crack 430 (FIG. 4a). In such instances, mechanical pressure can be applied along the scribed line to expand the crack 430 through the entire thickness t of glass 400 and thus achieve separation of glass sheet 100 and formation of laser-cut edge 120. Alternatively, the region surrounding the superficial median crack is heated using a second laser beam 415 (FIG. 4b), which is also an infrared laser, to advance the crack 435 vertically through the thickness t of the glass 400.

Because the process described above involves complete separation of glass sheet 100 from glass 400, the resulting laser-cut edge 120 is substantially free of any debris or defects that are greater than about 2 μm in size. Such debris and defects include chips, powder, or particulate matter. The absence of such defects and debris provides an advantage in terms of edge strength and process cleanliness. In addition, laser-cut edge 120 has an RMS roughness of up to about 1.5 nm, which is slightly greater than that achieved (0.8-1.5 nm) on polished flat surfaces.

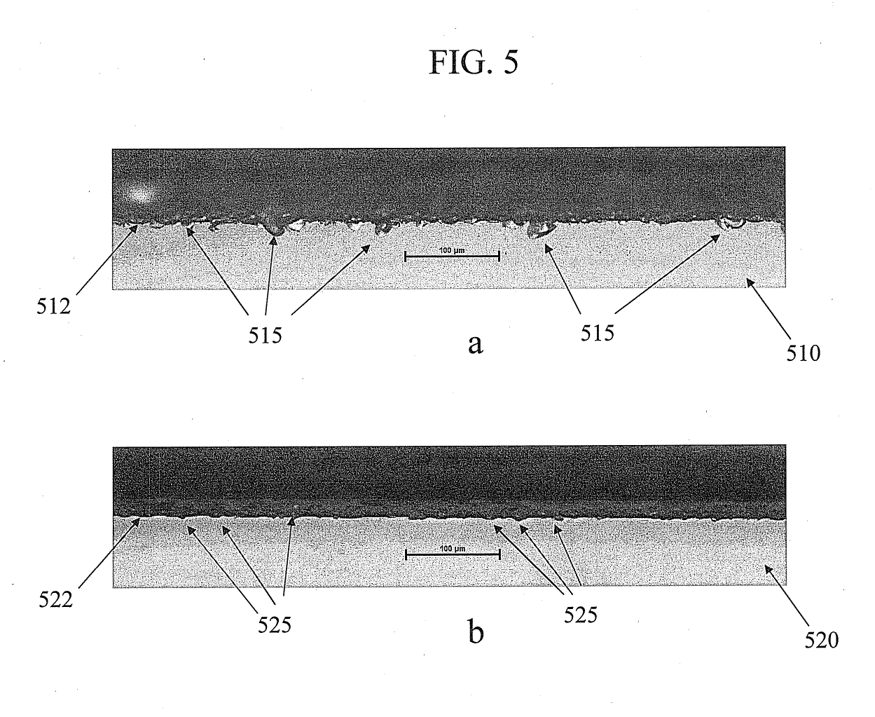

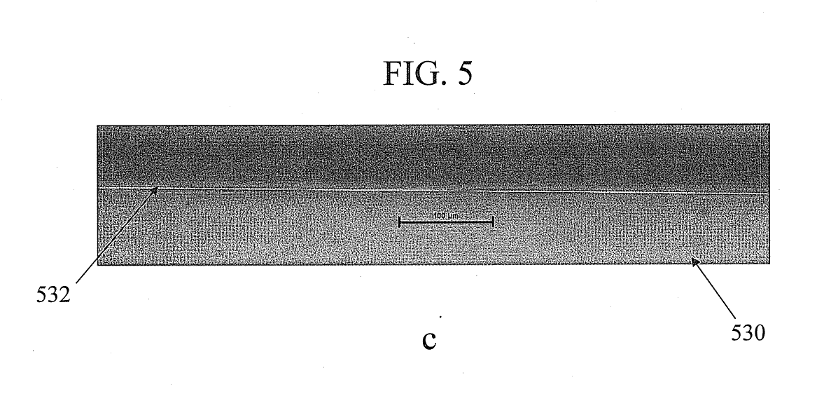

FIGS. 4a, 5b, and 5c are optical micrographs of: a) an edge 510 of a glass sheet formed by conventional scribing and breaking and computer numeric control (CNC) grinding; b) an edge 520 of a glass sheet formed by conventional scribing, breaking and CNC grinding and brush polishing; and c) a laser-formed edge 530 created by the methods described herein, respectively. Only surface damage is visible in FIGS. 5a, 5b, and 5c. Subsurface damage to the edges also exists, and the dimensions or sizes of such damage are typically about three times the peak-to-valley roughness of the surface of the edge. The edge 510 subjected to CNC grinding (FIG. 5a) has damage sites 515, which include chips, along the interface 512 between edge 510 and the surface of the glass sheet. The size of damage sites 515 ranges up to about 35 μm, and edge 510 has a RMS roughness of about 518 nm. Ground and brush polished edge 520 (FIG. 5b) has damage sites 525, which include chips, along the interface 522 between edge 520 and the surface. Damage sites 525 range in size up to about 10 μm, and the roughness of ground and brush polished edge 520 is about 99 nm. In contrast to the CNC ground and CNC ground and polished edges 510, 515, no damage is visible on either laser-formed edge 530 or along the interface 532 between the surface of the glass sheet and laser-formed edge 530. Damage sites present on laser-formed edge 530 or at interface 532 are less than about 1 μm in size. The RMS roughness of laser-formed edge 530 is 1.5 nm, which is less than those of CNC ground and CNC ground and polished edges 510, 515.

In addition to providing an edge that is substantially free of defects or debris, the time needed to form glass sheet 100 using the method of laser separation of glass described herein is less than that typically to required produce a finished edge by conventional means. Referring to FIGS. 4a and 4b, laser beam 410, coolant spray 420, and second laser beam 415 are typically translated across glass 400 at a rate of 25 mm/s to separate glass sheet 100 from a larger glass panel. At this rate, a 53 mm×107.5 mm cover plate for a cellular telephone, for example, can be formed in 12.85 seconds. In contrast to the laser separation method described herein, computer numeric control (CNC) edging of a cover plate having the dimensions described above requires about 6 minutes, and CNC machining and brush polishing of edges requires about two hours.

For mechanical processes that are typically used to cut glass sheets into a desired shape and size, it is necessary to grind and polish the edges of the plate to eliminate micro-cracks, chipping, and other defects that can dramatically decrease edge strength and resistance to breakage. Considering that the strength in brittle ceramics is related to the flaw size in material as given by the Griffith formula,

$${σ}_{f} = A \cdot {( \frac{E \cdot γ}{c} )}^{1 / 2} ,$$

where σ_{f} equals strength; E is Young's modulus; γ is the fracture surface energy; c is the flaw size; and A is a constant that depends on the shape of largest flaw and loading geometry, edge strength is impacted by the shape and size of defects that are present in the edge. Edge strength will be reduced by 29%, for example, when the flaw size is doubled. A strong edge is therefore obtained when the presence and size of defects generated during the separation process is either eliminated or minimized. The process of mechanically grinding and polishing the edge introduces defects having controlled sizes that are dictated by the size of the abrasive particles used in such operations. Failure to eliminate such defects often results in breakage during any process, such as, for example, handling of the glass sheet, that introduces stress around the defects.

Laser-formed edge 120 described herein provides enhanced damage resistance for glass sheet 100, and is sufficiently strong to withstand damage caused by between-process handling of glass sheet 100 or in-process edge damage, and to survive use in the final application. The as-processed laser-formed edge 120 possesses greater strength than conventionally processed (e.g. scoring, breaking, grinding, polishing) edges without added process steps, such as edging and chamfering. The absence of chips and damage generated by separation/cutting of the glass sheet and edging and chamfering operations also eliminates the need for subsequent lap/polish steps to remove damage at the chamfer/face interface. In addition, laser separation offers additional dimensional control not available via scoring and breaking, which helps to eliminate material loss by eliminating the need to reduce lateral part size via edging.

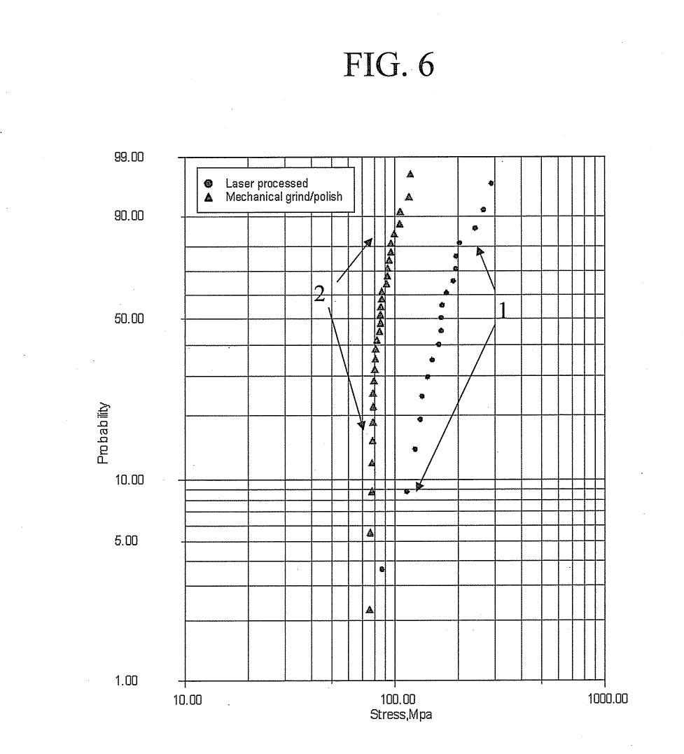

A Weibull plot comparing the vertical edge strength of samples having edges formed by the laser separation method described herein and samples having edges that were mechanically ground and polished is shown in FIG. 6. All samples were fusion drawn alkali aluminosilicate glass (66.7 mol % SiO₂; 10.5 mol % Al₂O₃; 0.64 mol % B₂O₃; 13.8 mol % Na₂O; 2.06 mol % K₂O; 5.50 mol % MgO; 0.46 mol % CaO; 0.01 mol % ZrO₂; 0.34 mol % As₂O₃; and 0.007 mol % Fe₂O₃) 100 mm×100 mm squares having a thickness 1.2 mm and 10 mm radius rounded corners. The samples were neither chemically nor thermally strengthened.

Data obtained for 19 samples prepared by the laser separation method described herein and 30 samples having edges that were mechanically ground and polished are shown in FIG. 6. All samples were submitted to 4 point modulus of rupture (MOR) testing. The laser separated samples have much stronger edges, which is a direct consequence of the fact that the laser separation process produces edges that are substantially free of defects. The distribution of the data obtained for the laser-formed samples is slightly broader than that of the ground and polished samples, with laser-formed edges breaking over a broader pressure range. However, the lowest vertical strength (about 90 MPa) observed for the laser separated samples (1 in FIG. 6) is comparable with the average of the mechanical processed samples (2 in FIG. 6).

Glass sheet 100 is down-drawn, using those methods known in the art such as, but not limited to fusion-drawing, slot-drawing, and the like. Glass sheets formed by float or slot-draw methods that are known in the art require lapping or polishing to satisfy thickness and finishing requirements for applications such as cover plates or windows for portable electronic communication or entertainment devices or the like. Down-drawn glass sheet 100, on the other hand, offers pristine surfaces having low roughness, large sizes, and a range of thicknesses. In some embodiments, glass sheet 100 is down-drawn to a thickness matching that of the final or desired product, and therefore does not require lapping or polishing to achieve the desired thickness. Fusion-drawn surfaces typically have a RMS roughness of up to 0.3 nm, and in one embodiment, ranging from 0.2 nm up to 0.3 nm, whereas polished surfaces have a RMS roughness ranging from 0.7 nm up to 1.4 nm. In one embodiment, at least one of surfaces 110, 115 is an as-drawn surface of the glass sheet.

The fusion draw process typically uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank. These outside surfaces extend downward and inwardly so that they join at an edge below the drawing tank. The two flowing glass surfaces join at this edge to fuse and form a single flowing sheet. The fusion draw method offers the advantage that, since the two glass films flowing over the channel fuse together, neither outside surface of the resulting glass sheet comes in contact with any part of the apparatus. Thus, the surface properties of the glass sheet are not affected by such contact.

The slot-draw method is distinct from the fusion-draw method. Here the molten raw material glass is provided to a drawing tank. The bottom of the drawing tank has an open slot with a nozzle that extends the length of the slot. The molten glass flows through the slot/nozzle and is drawn downward as a continuous sheet therethrough and into an annealing region. Compared to the fusion-draw process, the slot-draw process provides a thinner sheet, as only a single sheet is drawn through the slot, rather than two sheets being fused together, as in the fusion down-draw process.

In one embodiment, glass sheet 100 comprises, consists essentially of, or consists of a soda lime glass. In another embodiment, glass sheet 100 comprises, consists essentially of, or consists of any glass that can be down-drawn, such as, but not limited to, an alkali aluminosilicate glass. In one embodiment, the alkali aluminosilicate glass comprises: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 ppm As₂O₃; and less than 50 ppm Sb₂O₃; wherein 12 mol %≦Li₂O+Na₂O+K₂O≦20 mol % and 0 mol %≦MgO+CaO≦10 mol %. In another embodiment, the alkali aluminosilicate glass comprises: 64 mol %≦SiO₂≦68 mol %; 12 mol %≦Na₂O≦16 mol %; 8 mol %≦Al₂O₃≦12 mol %; 0 mol %≦B₂O₃≦3 mol %; 2 mol %≦K₂O≦5 mol %; 4 mol %≦MgO≦6 mol %; and 0 mol %≦CaO≦5 mol %, wherein: 66 mol %≦SiO₂+B₂O₃+CaO≦69 mol %; Na₂O+K₂O+B₂O₃+MgO+CaO+SrO<10 mol %; 5 mol %≦MgO+CaO+SrO≦8 mol %; (Na₂O+B₂O_{3)—Al}₂O₃≦2 mol %; 2 mol %≦Na₂O—Al₂O₃≦6 mol %; and 4 mol %≦(Na₂O+K₂O)—Al₂O₃≦10 mol %. In a third embodiment, the alkali aluminosilicate glass comprises: 50-80 wt % SiO₂; 2-20 wt % Al₂O₃; 0-15 wt % B₂O₃; 1-20 wt % Na₂O; 0-10 wt % Li₂O; 0-10 wt % K2O; and 0-5 wt % (MgO+CaO+SrO+BaO); 0-3 wt % (SrO+BaO); and 0-5 wt % (ZrO₂+TiO₂), wherein 0≦(Li₂O+K₂O)/Na₂O≦0.5.

In one particular embodiment, the alkali aluminosilicate glass has the composition: 66.7 mol % SiO₂; 10.5 mol % Al₂O₃; 0.64 mol % B₂O₃; 13.8 mol % Na₂O; 2.06 mol % K₂O; 5.50 mol % MgO; 0.46 mol % CaO; 0.01 mol % ZrO₂; 0.34 mol % As₂O₃; and 0.007 mol % Fe₂O₃. In another particular embodiment, the alkali aluminosilicate glass has the composition: 66.4 mol % SiO₂; 10.3 mol % Al₂O₃; 0.60 mol % B₂O₃; 4.0 mol % Na₂O; 2.10 mol % K₂O; 5.76 mol % MgO; 0.58 mol % CaO; 0.01 mol % ZrO₂; 0.21 mol % SnO₂; and 0.007 mol % Fe₂O₃. The alkali aluminosilicate glass is, in some embodiments, substantially free of lithium, whereas in other embodiments, the alkali aluminosilicate glass is substantially free of at least one of arsenic, antimony, and barium.

Non-limiting examples of such alkali aluminosilicate glasses are described in U.S. patent application Ser. No. 11/888,213, by Adam J. Ellison et al., entitled “Down-Drawable, Chemically Strengthened Glass for Cover Plate,” filed on Jul. 31, 2007, which claims priority from U.S. Provisional Patent Application 60/930,808, filed on May 22, 2007, and having the same title; U.S. patent application Ser. No. 12/277,573, by Matthew J. Dejneka et al., entitled “Glasses Having Improved Toughness and Scratch Resistance,” filed on Nov. 25, 2008, which claims priority from U.S. Provisional Patent Application 61/004,677, filed on Nov. 29, 2007, and having the same title; U.S. patent application Ser. No. 12/392,577, by Matthew J. Dejneka et al., entitled “Fining Agents for Silicate Glasses,” filed Feb. 25, 2009, which claims priority from U.S. Provisional Patent Application No. 61/067,130, filed Feb. 26, 2008, and having the same title; U.S. patent application Ser. No. 12/393,241 by Matthew J. Dejneka et al., entitled “Ion-Exchanged, Fast Cooled Glasses,” filed Feb. 26, 2009, which claims priority from U.S. Provisional Patent Application No. 61/067,732, filed Feb. 29, 2008. and having the same title; and U.S. Provisional Patent Application No. 61/087,324, by Kristen L. Barefoot et al., entitled “Chemically Tempered Cover Glass,” filed Aug. 8, 2008, the contents of which are incorporated herein by reference in their entirety.

In one embodiment, glass sheet 100 is strengthened after being cut or separated by the means described hereinabove. Glass sheet 100 can be either thermally or chemically strengthened. The strengthened glass sheet 100 has strengthened surface layers extending from a first surface and a second surface to a depth of layer below each surface. The strengthened surface layers are under compressive stress, whereas a central region of glass sheet 100 is under tension, or tensile stress, so as to balance forces within the glass. In thermal strengthening (also referred to herein as “thermal tempering”), glass sheet 100 is heated up to a temperature that is greater than the strain point of the glass but below the softening point of the glass and rapidly cooled to a temperature below the strain point to create strengthened layers at the surfaces of the glass. In another embodiment, glass sheet 100 can be strengthened chemically by a process known as ion exchange. In this process, ions in the surface layer of the glass are replaced by—or exchanged with—larger ions having the same valence or oxidation state. In those embodiments in which glass sheet 100 comprises, consists essentially of, or consists of an alkali aluminosilicate glass, ions in the surface layer of the glass and the larger ions are monovalent alkali metal cations, such as Li⁺ (when present in the glass), Na⁺, K⁺, Rb⁺, and Cs⁺. Alternatively, monovalent cations in the surface layer may be replaced with monovalent cations other than alkali metal cations, such as Ag⁺ or the like.

Ion exchange processes are typically carried out by immersing a glass article in a molten salt bath containing the larger ions to be exchanged with the smaller ions in the glass. It will be appreciated by those skilled in the art that parameters for the ion exchange process, including, but not limited to, bath composition and temperature, immersion time, the number of immersions of the glass in a salt bath (or baths), use of multiple salt baths, additional steps such as annealing, washing, and the like, are generally determined by the composition of the glass and the desired depth of layer and compressive stress of the glass to be achieved by the strengthening operation. By way of example, ion exchange of alkali metal-containing glasses may be achieved by immersion in at least one molten salt bath containing a salt such as, but not limited to, nitrates, sulfates, and chlorides of the larger alkali metal ion. The temperature of the molten salt bath typically is in a range from about 380° C. up to about 450° C., while immersion times range from about 15 minutes up to about 16 hours. However, temperatures and immersion times different from those described above may also be used. Such ion exchange treatments typically result in strengthened alkali aluminosilicate glasses having depths of layer ranging from about 10 μm up to at least 50 μm with a compressive stress ranging from about 200 MPa up to about 800 MPa, and a central tension of less than about 100 MPa.

Non-limiting examples of ion exchange processes are provided in the U.S. patent applications and provisional patent applications that have been previously referenced hereinabove. Additional non-limiting examples of ion exchange processes in which glass is immersed in multiple ion exchange baths, with washing and/or annealing steps between immersions, are described in U.S. Provisional Patent Application No. 61/079,995, by Douglas C. Allan et al., entitled “Glass with Compressive Surface for Consumer Applications,” filed Jul. 11, 2008, in which glass is strengthened by immersion in multiple, successive, ion exchange treatments in salt baths of different concentrations; and U.S. Provisional Patent Application No. 61/084,398, by Christopher M. Lee et al., entitled “Dual Stage Ion Exchange for Chemical Strengthening of Glass,” filed Jul. 29, 2008, in which glass is strengthened by ion exchange in a first bath is diluted with an effluent ion, followed by immersion in a second bath having a smaller effluent ion concentration than the first bath. The contents of U.S. Provisional Patent Application Nos. 61/079,995 and No. 61/084,398 are incorporated herein by reference in their entirety.

A method of making the glass sheet 100 described herein is also provided. A first glass sheet or panel is first provided, and glass sheet 100 is formed from a portion of the first glass sheet by separating the glass sheet 100 from the first glass sheet along a plane. Glass sheet 100 is separated by laser-forming an edge 120 of glass sheet 100 along the plane, wherein the laser-formed edge 120 has a minimum edge strength of at least about 90 MPa. The laser-formed edge 120 is formed using those methods described hereinabove. In one embodiment, glass sheet 100 is either chemically or thermally strengthened after separation from the first glass sheet.

Glass sheet 100 can be used as a protective cover plate (as used herein, the term “cover plate” includes windows and the like) for display and touch screen applications, such as, but not limited to, portable communication and entertainment devices such as telephones, music players, video players, or the like; and as a display screen or touch screen for information-related terminal (IT) devices (e.g., portable or laptop computers); as well as in other applications.

While typical embodiments have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

1. A glass sheet, the glass sheet comprising:
a. at least one surface that is transparent and unpolished; and
b. at least one laser-formed edge that is substantially free of a chamfer or a bevel, wherein the glass sheet has a minimum edge strength of at least about 90 MPa, and wherein the glass sheet is down-drawn.

2. The glass sheet according to claim 1, wherein the glass sheet is a strengthened glass sheet.

3. The glass sheet according to claim 2, wherein the glass sheet is strengthened by ion exchange.

4. The glass sheet according to claim 1, wherein the at least one laser-formed edge is substantially free of defects having a dimension of at least 2 μm.

5. The glass sheet according to claim 1, wherein the laser-formed edge has a Ra roughness of up to about 2 nm.

6. The glass sheet according to claim 1, wherein the glass sheet is fusion-drawn.

7. The glass sheet according to claim 1, wherein the at least one surface has a Ra roughness of up to about 0.3 nm.

8. The glass sheet according to claim 1, wherein the glass sheet has at least one radially cut corner.

9. The glass sheet according to claim 1, wherein the at least one edge is perpendicular to the at least one surface.

10. The glass according to claim 1, wherein the glass sheet has a thickness of up to about 2 mm.

11. The glass sheet according to claim 1, wherein the glass sheet comprises one of a soda lime glass and an alkali aluminosilicate glass.

12. The glass sheet according to claim 11, wherein the alkali aluminosilicate glass comprises: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 ppm As₂O₃; and less than 50 ppm Sb₂O₃; wherein 12 mol %≦Li₂O+Na₂O+K₂O≦20 mol % and 0 mol %≦MgO+CaO≦10 mol %.

13. The glass sheet according to claim 11, wherein the alkali aluminosilicate glass comprises: 50-80 wt % SiO₂; 2-20 wt % Al₂O₃; 0-15 wt % B₂O₃; 1-20 wt % Na₂O; 0-10 wt % Li₂O; 0-10 wt % K₂O; and 0-5 wt % (MgO+CaO+SrO+BaO); 0-3 wt % (SrO+BaO); and 0-5 wt % (ZrO₂+TiO₂), wherein 0≦(Li₂O+K₂O)/Na₂O≦0.5.

14. The glass sheet according to claim 1, wherein the glass sheet is one of a cover plate for a portable electronic device and a display screen for an information-related terminal device.

15. A strengthened glass sheet, the strengthened glass sheet comprising:
a. a first surface and a second surface; and
b. at least one laser-formed edge joining the first major surface and the second major surface, wherein the at least one laser-cut edge is substantially free of a chamfer or a bevel, and wherein the strengthened glass sheet is fusion drawn.

16. The strengthened glass sheet according to claim 15, wherein the strengthened glass sheet has a minimum strength of at least about 90 MPa.

17. The strengthened glass sheet according to claim 15, wherein the strengthened glass sheet is one of a cover plate for a portable electronic device and a display screen for an information-related terminal device.

18. The strengthened glass sheet according to claim 15, wherein the glass sheet has at least one radially cut corner.

19. The strengthened glass sheet according to claim 15, wherein the at least one laser-formed edge is perpendicular to the first surface and the second surface.

20. A method of making a glass sheet, the method comprising the steps of:
a. providing a down-drawn first glass sheet; and
b. separating the glass sheet from the down-drawn first glass sheet along a plane to form the glass sheet from a portion of the first glass sheet, wherein separating the glass sheet comprises laser-forming an edge of the glass sheet along the plane, and wherein the edge is substantially free of a chamfer or a bevel and has a minimum edge strength of at least about 90 MPa.

21. The method according to claim 20, wherein the step of separating the glass sheet from the first glass sheet comprises:
a. initiating a flaw in a surface of the first glass sheet;
b. irradiating the first glass sheet with a laser to create a vent originating at the flaw; and
c. quenching the first glass sheet along the vent to separate the glass sheet from the first glass sheet.

22. The method of claim 20, wherein the step of separating the glass sheet from the first glass sheet comprises:
a. irradiating a portion of the surface of the first glass sheet with a first laser beam to create a thermal stress;
b. quenching the glass sheet along the superficial median crack to form a superficial median crack; and
c. irradiating the first glass sheet with a second laser to expand the median crack through a thickness of the first glass sheet to separate the glass sheet from the first glass sheet along a plane perpendicular to the surface.

23. The method according to claim 20, further comprising strengthening the glass sheet.

24. The method according to claim 23, wherein the step of strengthening the glass sheet comprises exchanging ions within the first glass sheet, each of the ions in the first sheet having a first ionic radius, with ions having an ionic radius that is greater than the first ionic radius.

25. The method according to claim 20, wherein the step of providing the down-drawn first glass sheet comprises fusion drawing the first glass sheet.
